(19) United States
(12) Patent Application Publication
(10) Pub. No.: US 2026/0151738 A1
(43) Pub. Date: Jun. 4, 2026

(54) FILTER DEVICE WITHOUT CLAMPING BOLTS

(71) Applicant: R. T.S. ROCHEM TECHNICAL SERVICES GmbH, Hamburg (DE)

(72) Inventor: Ralf FAIGA, Hamburg (DE)

(73) Assignee: R. T.S. ROCHEM TECHNICAL SERVICES GmbH, Hamburg (DE)

(21) Appl. No.: 19/124,191

(22) PCT Filed: Oct. 17, 2023
(86) PCT No.: PCT/EP2023/078863

§ 371 Date: Apr. 24, 2025

(30) Foreign Application Priority Data
Oct. 25, 2022 (DE) 102022128233.3

(51) Int. Cl. B01D 63/10

(52) U.S. Cl. CPC B01D 63/10; B01D 2313/02; B01D 2313/20

(57) ABSTRACT

The invention relates to a filter device for filtering a fluid, comprising a membrane insert disposed in a housing and having a plurality of membranes for filtering the fluid. The housing comprises a cylindrical housing tube having a first end element at a first tube end and a second tube element at a second tube end, wherein the membrane insert is disposed between the first end element and the second end element. The filter device comprises no bolt element connecting the end elements to each other for preloading the first end element and the second end element in the direction of the membrane insert.

The present invention relates to a filter device for filtering a fluid by means of membranes.

The use of membranes for filtering fluids is fundamentally known. Corresponding filter devices are used, for example, for treating drinking water and typically comprise a housing having an inlet for the fluid, a permeate outlet for the permeate separated from the fluid, and a retentate outlet for the retentate (concentrate) separated from the fluid. A membrane insert supporting one or more membranes for separating or filtering the fluid is present inside the housing. The membrane insert is advantageously disposed in a cylindrical housing tube closed off at the ends by means of end elements. The housing can be particularly pressure-tight in design in this manner, so that the fluid to be filtered can also be pumped through the membrane insert at high pressure.

When the filter device is used as intended, the fluid to be filtered impinges on the membranes in that the fluid is guided through the inlet into the interior of the housing tube and is pressed through the membrane insert in order to obtain the permeate and the retentate. The permeate is that part of the fluid passing through the membranes and is thereby freed of undesired components. The latter are retained in the retentate.

When using a plurality of fine-pored membranes, such as for ultrafiltration, the fluid is subjected to pressure from the inlet side in order to separate the fluid into the permeate and the retentate as quickly as possible. As a result, an interior pressure arises inside the housing and acts on the housing wall and particularly also on the two end elements closing off the housing. Depending on the filter application (e.g., microfiltration, ultrafiltration, and nanofiltration), the pressure can be 120 bar or greater, particularly when using very finely porous membranes. In order to nevertheless avoid pressure-related damage to the housing or leakage during operation of the filter device, the end elements have previously been connected to each other by means of a clamping bolt extending through the membrane insert. The clamping bolt clamps the end elements in the direction of the membrane insert, so that the pressure forces acting on the end elements from the inside are reliably compensated for.

However, the clamping bolt is associated with disadvantages. Firstly, the clamping bolt reduces the space in the interior of the housing available for the membrane insert and thus for filtering. The fluid flow generated during filtering is therefore diminished by the clamping bolt, so that the amount of fluid able to be filtered per unit of time is limited by the clamping bolt. The flow rate is also limited if the clamping bolt is disposed behind the membranes in the flow direction, for example if the clamping bolt is fed through a permeate tube extending through the membrane insert. In other words, the spatial volume available on the permeate side also affects the filter performance.

The clamping bolt also increases the weight of the filter device and the effort for reliable sealing.

The object of the invention is to disclose an improved filter device particularly allowing a greater flow rate for the retentate.

The object is achieved according to a first consideration by the subject-matter of claim 1.

Accordingly, the filter device comprises no bolt element connecting the first and second end elements to each other for preloading the first end element and the second end element in the direction of the membrane insert.

It has been found that sufficient pressure resistance of the housing can be ensured even without the clamping bolt. In other words, the clamping bolt can be eliminated without compromising the function and safety of the filter device. The flow rate of the fluid to be filtered, particularly the permeate portion, can be significantly increased in this manner. Furthermore, the weight and risk of leakage can be reduced.

The clamping bolt may be eliminated in particular in applications that do not require particularly high filter pressures, for example in the range of 120 bar and greater. In addition, the filter device may be implemented by various design measures such that the end elements are always securely retained on the housing tube and no leakages occur, even without a clamping bolt. Examples of suitable measures are described below.

The filter device described may fundamentally be used for various filtering purposes. Non-exclusive examples include ultrafiltration, reverse osmosis, and nanofiltration.

Embodiments are disclosed in the description, the dependent claims, and the figures.

According to one embodiment, the filter device preferably comprises no bolt element extending through the membrane insert and the first and/or second end element. The effective area of the membrane insert can be enlarged in this manner. In addition, there are fewer design requirements for at least one of the end elements, particularly with respect to reliable sealing of an opening formed in the end element. For example, an end element with no opening for the bolt element may be implemented, so that the risk of leakage is reduced.

According to a further embodiment, the membrane insert comprises a permeate tube connected to the membranes for receiving and discharging the permeate. The permeate tube preferably extends centrally through the membrane insert and the housing tube. For example, the permeate tube and the housing tube may be disposed concentric to each other or having parallel axes.

The permeate tube is particularly fully clear along the axis of the tube, particularly free of any bolt element. The central discharge region for the permeate is thus unhindered by either a bolt element or any other connecting element potentially reducing the volume of the permeate tube. The flow rate of the fluid through the filter device, particularly the permeate portion, can be further increased by said measures.

According to a further embodiment, at least one of the ends of the permeate tube contacts one of the end elements of the housing. For example, the first tube end of the permeate tube contacts the first end element. In addition or alternatively, the second tube end may contact the axially opposite second end element. Movement of the permeate tube can be effectively limited in this manner, so that the membrane insert is retained at a fixed position in the housing tube. Furthermore, the end elements can be advantageously centrally supported on the permeate tube. For example, the permeate tube may directly support the end elements, so that separate contact pressure elements can be eliminated.

According to a further embodiment, the first tube end of the permeate tube engages in segments in a central recess of the first end element, in order to limit the movement of the permeate tube in the axial direction toward the first end element. The first tube end may thereby optionally have a sealing element in order to particularly reliably prevent the fluid from entering the permeate tube. The sealing element is preferably implemented as a sealing ring. Said ring may contribute to retaining the permeate tube in the recess and particularly to preventing said tube from slipping out of the recess.

It is preferable that the second tube end of the permeate tube engages in segments in a central opening of the second end element. The permeate tube can thus be advantageously mounted in both end elements. The opening enables access to the interior of the permeate tube when needed. For example, the opening may have an internal thread into which a connector for the permeate tube or the permeate outlet is threaded. The connector may be removed as desired by unscrewing in order to expose and optionally to clean the end of the permeate tube.

Furthermore, measures for compensating for gaps due to manufacturing or operations may also be taken. For example, the connector may define a stop for the permeate tube able to be variably adjusted depending on the thread-in depth. The movement of the permeate tube can be limited in particular such that displaceability of the permeate tube and of the membrane insert in the axial and radial directions is minimized.

The connector preferably comprises a sealing element for preventing fluid from escaping the housing. Furthermore, the second tube end of the permeate tube may also comprise a sealing element for preventing retentate from penetrating into the permeate tube and/or for improving the seating of the permeate tube in the opening.

The permeate outlet is preferably disposed centrally on the second end element. For example, the permeate outlet may be implemented on the previously mentioned connector. The achievable outflow rate of permeate can thereby be further increased.

According to a further embodiment, the inlet is disposed off-center on the first end element and the retentate outlet is disposed off-center on the second end element. The inlet and the retentate outlet may also be transposed as need in order to operate the filter device with a reversed fluid flow.

The arrangement of all inlets and outlets at the end elements is advantageous in order to be able to implement the housing tube without interruption, that is, without openings for connections or the like. The design requirements for the housing tube can thereby be reduced. For example, the housing tube may be advantageously made of a plastic. Said plastic may be reinforced with fibers, particularly glass fibers, for high-pressure applications. In addition, the risk of leakage at the housing tube is minimized.

Preferably, the first end element and/or the second end element are each detachably secured by means of one retaining ring against falling out of the housing tube. The retaining ring engages in a groove running circumferentially about the tube axis on an inner side of the housing tube and is preloaded radially outwardly.

According to a further embodiment, the filter device is equipped with a preload element, particularly an adjusting flange, having at least one threaded hole. The threaded hole preferably extends axially parallel to the tube axis of the housing tube and serves for receiving a screw for preloading the first and/or second end element in the direction of the membrane insert. The screw is preferably threaded into the threaded hole from the outside until said screw interacts with the adjacent end element in the axial direction. In this manner, the end element can be preloaded against the membrane insert in the axial direction as a function of the thread-in depth in order to reliably retain the end element and the membrane insert at a fixed position in the housing tube. Tolerance effects due to manufacturing or operations can be compensated for by readjusting the screw as needed.

In a preferred embodiment, the preload element is annular in shape and comprises a plurality of threaded holes disposed along the ring. For example, the preload element may be implemented as an annular flange. The threaded holes are each implemented for receiving a screw in order to load the end element in the direction of the membrane insert. The use of a plurality of screws can reliably prevent misalignment of the end element in the housing tube. The point loads on the end element are also reduced because the preload force is distributed across the plurality of screws.

According to a further embodiment, at least one deflecting device is disposed between the membrane insert and the inlet in order to deflect the fluid flow in the housing tube. The fluid flow may be particularly deflected such that mechanical overloading of the membranes in segments by inflowing fluid is prevented. For example, the deflecting device may be implemented as a disk extending transverse to the tube axis of the housing and forming a fluid barrier in the direction toward the membranes. The fluid must consequently flow around the disk before the fluid impinges on the membranes. The flow rate per area can be effectively reduced or limited in this manner. The overall flow rate, however, is not degraded, so that high filter performance can nevertheless be achieved.

The deflecting device is preferably attached to the end element comprising the inlet for the fluid. A further deflecting device may be disposed between the membrane insert and the retentate outlet. In this manner, the membrane side facing toward the retentate outlet is also protected against overloading. This is advantageous particularly when the retentate outlet is selectively used as an inlet for the fluid to be filtered.

According to a further embodiment, the membrane insert comprises one mesh-like intermediate element for enclosing the membranes at each of the sides thereof facing toward the end elements. The membranes are effectively retained in position by the intermediate elements. The membranes are also mechanically protected. For example, damage during installation can be better prevented.

The housing tube is preferably made of a plastic. The plastic may be advantageously reinforced with fibers, such as glass fibers, in order to be dimensionally stable under high internal pressures.

According to a second aspect of the invention, a filter device for filtering a fluid is described. The filter device comprises a housing having an inlet for the fluid, a permeate outlet for the permeate separated from the fluid, a retentate outlet for the retentate separated from the fluid, and a membrane insert having a plurality of membranes for filtering the fluid. A deflecting device is disposed between the membrane insert and the inlet and is implemented for deflecting a fluid flow when the filter device is used as intended. The deflecting device enables operating the filter device at higher flow rates. In particular, overloading of the membranes in segments by the incoming fluid flow is reliably prevented.

The deflecting device is preferably implemented as a disk element, as described above, ensuring uniform distribution of the fluid flow. For example, the disk element may bound an inlet channel for the fluid in the direction of a tube axis of the housing. The disk element is preferably directly attached to an end element disposed in the housing and comprising the inlet for the fluid.

The end elements are preferably made of a metal, particularly a stainless steel. The strength of the housing can be better ensured in this manner, even without clamping bolts.

It should be understood that the features disclosed in relation to the filter device according to the first consideration may also be implemented correspondingly in the most recently described filter device according to the second consideration, and vice versa. For example, the housing may also comprise a housing tube made of plastic in which the end elements are inserted at the ends.

According to a third aspect of the invention, a filter device for filtering a fluid is disclosed. Said filter device comprises a housing having an inlet for the fluid, a permeate outlet for the permeate separated from the fluid, and a retentate outlet for the retentate separated from the fluid. The housing comprises a cylindrical housing tube in which a membrane insert having a plurality of membranes for filtering the fluid is disposed. The membrane insert further comprises a permeate tube connected to the membranes for receiving and discharging the permeate. The permeate tube extends centrally through the membrane insert and is clear along the tube axis thereof, particularly free of any bolt element.

It should be understood that the features disclosed in relation to the filter devices described according to the first two considerations may also be implemented correspondingly in the most recently described filter device according to the third consideration, and vice versa. For example, the embodiments disclosed in the dependent claims may be implemented by the filter device according to the third consideration.

The invention is described in a purely exemplary manner in a preferred embodiment with reference to the drawings, wherein further advantageous details are disclosed.

Functionally identical components are indicated by the same reference numeral.

The drawings show, in detail:

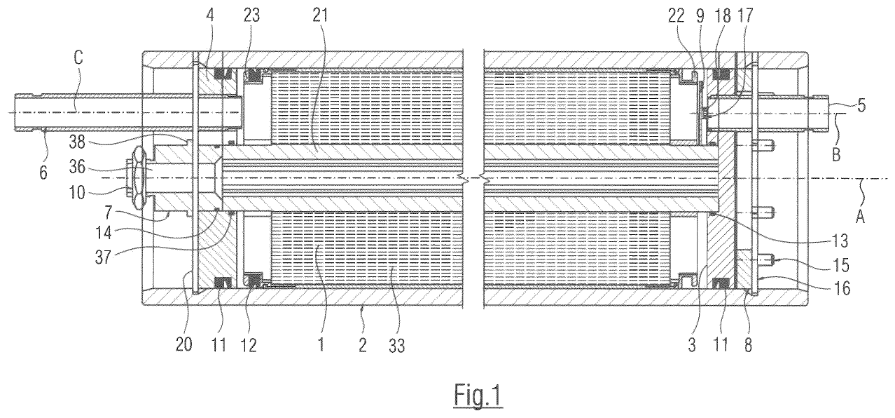

FIG. 1: a longitudinal section view of a filter device for filtering a fluid;

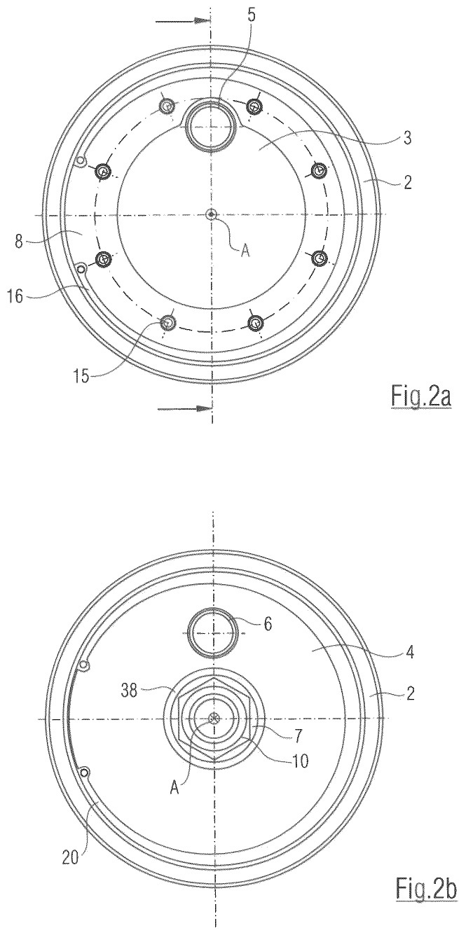

FIGS. 2a and 2b: side views of the end faces of the filter device of FIG. 1;

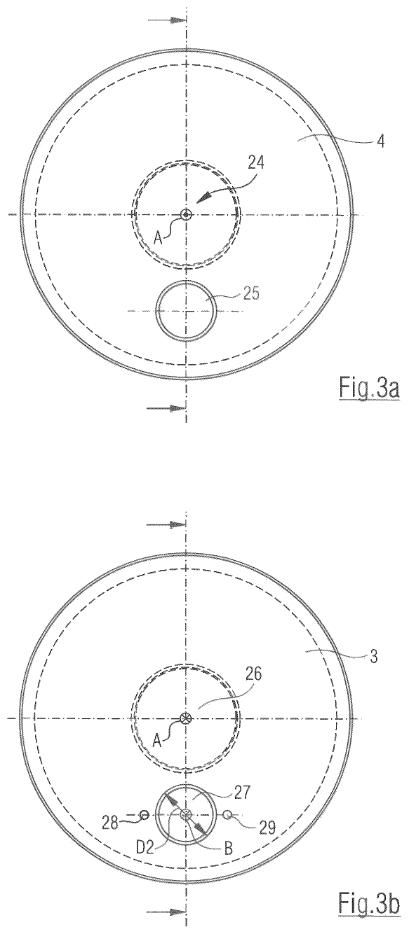

FIGS. 3a and 3b: side views of end elements of the filter device of FIG. 1;

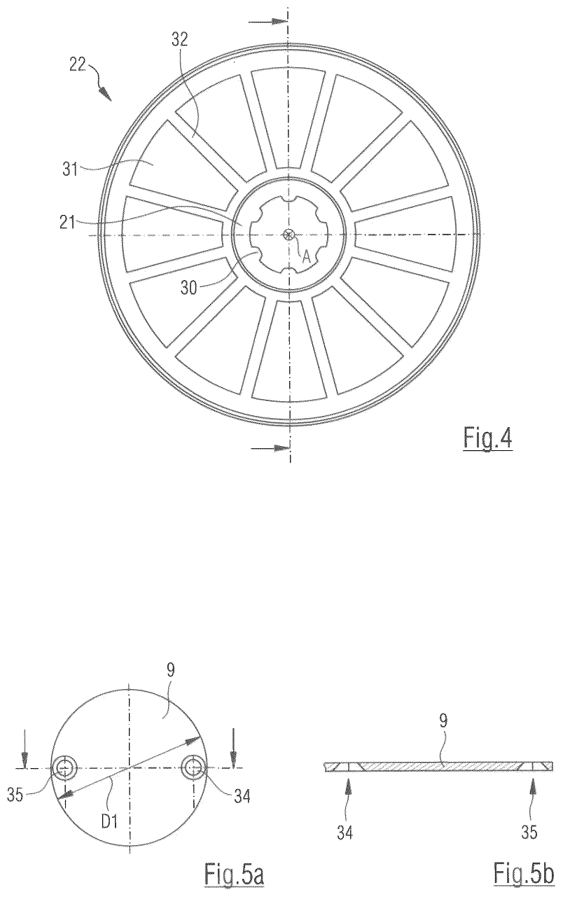

FIG. 4: a side view of an intermediate element of the filter device of FIG. 1;

FIGS. 5a and 5b: a side view (FIG. 5a) and a cross-sectional view (FIG. 5b) of a disk-shaped deflecting device for the filter device of FIG. 1;

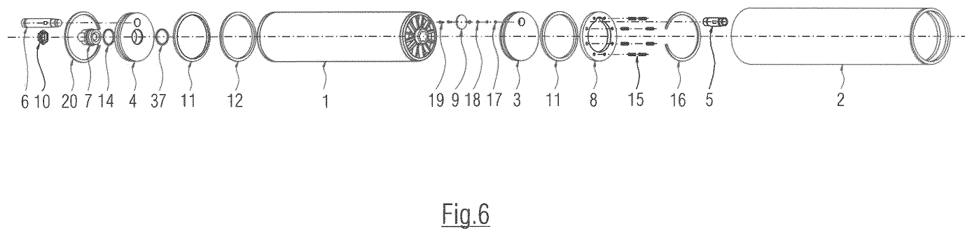

FIG. 6: an exploded view of the filter device of FIG. 1.

A filter device for filtering fluids is described below with reference to the figures. FIG. 1 shows a longitudinal section view of the filter device in an assembled state. The longitudinal axis of the device is defined by a central geometric axis A lying in the section plane. Individual parts of the filter device are illustrated in more detail in the exploded view of FIG. 6.

The filter device comprises a hollow cylindrical housing tube 2 in which a membrane insert 1 is disposed. The membrane insert 1 comprises a cylindrical outer shape adapted to the housing tube 2, wherein the membrane insert 1 contacts the inner side of the housing tube 2 along the circumferential surface thereof. The housing tube 2 is made of glass-fiber reinforced plastic. However, other plastics and materials are also conceivable.

The membrane insert 1 comprises a plurality of membranes 33 implemented as sheets and wound about a hollow cylindrical permeate tube 21. The permeate tube 21 extends coaxially to the housing tube 2 with respect to the axis A. The membranes 33 are disposed in the form of membrane cushions, as described in the document EP 1 445 013A1 , for example.

The individual membrane surfaces extend parallel to the axis A and are layered one over the other in the radial direction (cf. dashed lines in FIG. 1). The membranes 33 are implemented for separating a fluid to be filtered, such as contaminated water, into the permeate penetrating through the membranes 33 and the retained retentate. The membranes 33 engage in the permeate tube 21 in segments in order to discharge the obtained permeate into the permeate tube 21.

When the filter device is used as intended, the fluid to be filtered is fed into the interior of the housing tube 2 through a hollow cylindrical inlet tube 5 in order to be filtered there by means of the membrane insert 1. The end of the inlet tube 5 engages in a first disk-shaped end element 3 closing off the housing tube 2 at a first opening side (cf. FIG. 1 and FIG. 2a).

The end element 3 comprises an opening 27 disposed off-center into which the inlet tube 5 is threaded in segments. A tube axis B of the inlet tube 5 extends in the axial direction parallel to the axis A of the housing tube 2 and in the radial direction between the axis A and the wall of the housing tube 2 (cf. FIG. 1).

The end element 3 comprises a circumferential groove having a lip seal ring 11 for sealing off the end element 3 at the inner side of the housing tube 2 (cf. FIG. 1). In addition, the end element 3 is secured against falling out of the housing tube 2 by a retaining ring 16, also referred to as a securing ring (cf. FIG. 1 and FIG. 2a). The retaining ring 16 engages in a circumferential groove of the housing tube 2 running on the inside about the axis A and is preloaded outwardly in the radial direction.

An annular flange 8 is disposed between the retaining ring 16 and the end element 3 (cf. FIG. 2a). The flange 8 is directly adjacent to the end element 3 in the direction of axis A and is configured to displace and preload the end element 3 axially in the direction toward the membrane insert 1. To this end, the flange 8 comprises a plurality of threaded holes into which one threaded pin 15 each is threaded (cf. FIG. 1 and FIG. 2a). The threaded pins 15 act on the end element 3 as a function of the thread-in depth thereof in order to impinge on said end element along the axis A in the direction of the membrane insert 1. As shown in FIG. 2a, the flange 8 advantageously comprises a plurality of threaded holes 15 distributed along the flange 8. The end element 3 can consequently be uniformly loaded by successively threading in the threaded pins 15 without becoming misaligned or deformed in the housing tube 2.

The end element 3 comprises a central, circular recess 26 on the side thereof facing toward the membrane insert 1, in which recess one end of the permeate tube 21 is supported (cf. FIG. 1 and FIG. 3b). The end of the permeate tube 21 engaging in the recess 26 is sealed off by means of a sealing ring 13, so that the fluid does not enter the permeate tube 21 along the recess 26 without being filtered. The recess 26 comprises a floor limiting the axial displaceability of the permeate tube 21 (cf. FIG. 1).

The end element 3 acts on the permeate tube 21 when loaded by the flange 8 and the threaded pins 15. Reliable sealing of the permeate tube 21 is thereby improved.

The housing tube 2 is closed off on a second opening side opposite the first opening side by means of a second, disk-shaped end element 4 (cf. FIG. 1). Like the first end element 3, the second end element 4 is sealed off at the inner side of the housing tube 2 by means of a circumferential lip seal 11 and is secured against falling out of the housing tube 2 by a retaining ring 20.

An outlet tube 6 for the retentate is threaded into an off-center opening 25 of the end element 4 from the outside (cf. FIG. 1, FIG. 2b, and FIG. 3a). An axis C of the outlet tube 6 extends parallel to the axis A and in the radial direction between the axis A and the wall of the housing tube 2. In addition, the axis C is disposed coaxial to the axis B of the inlet tube 5, as shown in FIG. 1. However, a non-coaxial arrangement of the axes is also conceivable.

The end element 4 comprises a central, circular opening 24 (cf. FIG. 1 and FIG. 3a) extending in the direction of axis A and through the end element 4 and disposed coaxial to axis A. A connector 7 is threaded into the opening 24 from the outside and partially closes off the opening 24. On the inner side, one end of the permeate tube 21 engages in the opening 24, wherein the permeate tube 21 opens directly into a cylindrical hollow space 36 of the connector 7 (cf. FIG. 1). The permeate tube 21 and the connector 7 together define a linear discharge channel for the permeate.

The end of the permeate tube 21 engaging in the opening 24 has a sealing ring 37. In addition, the segment of the connector 7 engaging in the opening 24 comprises a sealing ring 14 in order to seal off the transition between the permeate tube 21 and the connector 7 from the outside.

The connector 7 has a flange segment 38 defining an axial stop and particularly preventing the connector 7 from being threaded too far into the opening 24. Mechanical overloading of the permeate tube 21 can be reliably prevented in this manner. The connector 7 has a tube segment and a nut 10 optionally threaded on toward the outside, serving to connect to a discharge line for the permeate, not shown.

The membrane insert 1 comprises an intermediate element 22, 23 between the membranes 33 and the end elements 3 and 4 in the axial direction for laterally enclosing the membranes 33, that is, in the direction of axis A and in the radial direction. A side view of the axial end face of the intermediate element 22 is shown in FIG. 4 (axis A extends perpendicular to the plane of the paper in FIG. 4). It is evident that the intermediate element 22 is implemented in the form of a mesh having a plurality of bars 32 extending in a star shape in the radial direction about the permeate tube 21. Trapezoidal openings 31 are formed between the bars 32 and permit fluid flow in the direction toward the membranes 33 (not shown in FIG. 4).

The permeate tube 21 comprises a plurality of ribs 30 spaced apart circumferentially and extending parallel to axis A on the inner side thereof. The inner side may alternatively be implemented without ribs, that is, in the manner of a smooth-walled hollow cylinder. In the region of axis A, however, the permeate tube 21 comprises no bolt element or similar connecting elements extending in the axial direction through the permeate tube 21. In other words, the permeate tube 21 is clear or hollow along the entire axial length thereof, particularly when the filter device is used as intended. This enables a very high flow rate for the permeate.

A deflecting disk 9 is disposed on the end element 3 and deflects the fluid flow through the inlet tube 5 in the radial direction. In this manner, the fluid flow is prevented from impinging on the membranes 33 directly along axis B (cf. FIG. 1, FIG. 5a, and FIG. 5b). In other words, the fluid must first flow around the deflecting disk 9, whereby the membranes 33 are protected against overloading in segments due to inflowing fluid. The fluid can therefore be pumped through the inlet tube 5 at high pressure without a problem in order to filter a large volume of fluid per unit of time.

The deflecting disk 9 comprises two holes 34 and 35 off-center for passing through one screw 19 each in order to attach the deflecting disk 9 directly to the end element 3. The holes 34, 35 preferably have a countersink for receiving a countersunk head of the screw 19, as shown in FIG. 5b and FIG. 5b. In the attached state, the side of the deflecting disk 9 facing toward the membrane insert 1 has a smooth surface (cf. FIG. 1).

The deflecting disk 9 bounds the fluid channel formed by the inlet tube 5 in the direction of axis B. However, a gap is formed between the deflecting disk 9 and the end element 3, so that fluid is deflected in a substantially radial direction and flows to the membrane insert 1 when the filter device is used as intended. The gap width is defined by a nut 17 and a washer 18 (cf. FIG. 1). The gap width may, however, be adjusted as needed in that further and/or different spacing elements are used.

The diameter D1 of the deflecting disk 9 is adapted to the diameter D2 of the inlet tube 5 or to the diameter of the opening 27 (cf. FIG. 5a and FIG. 3b). In particular, the diameter D1 is approximately double the diameter D2. The protection of the membranes 33 can thereby be particularly well ensured. Furthermore, the deflecting disk 9 forms a negligible flow resistance for the fluid.

The end element 3 comprises two threaded holes 28 and 29 on the side facing toward the membrane insert 1, said holes being disposed adjacent to the opening 27 and diametrally opposite with respect to the opening 27 (cf. FIG. 3b). The spacing between the threaded holes 28, 29 corresponds to the spacing between the holes 34, 35 of the deflecting disk 9. The threaded holes 28, 29 serve for threading in the screws 19 in order to attach the deflecting disk 9 to the end element 3.

The filter device enables an unusually high filter performance due to high fluid flows. To this end, the fluid can be pumped into the inlet tube 5 at high pressure as well. However, the use of a conventional clamping bolt for connecting the end elements 3 and 4 to each other through the permeate tube 21 and preloading the same inwardly, that is, in the direction of the membrane insert 1, can be eliminated. As a result, the free discharge of the permeate through the permeate tube 21 can be particularly well ensured. In addition, the permeate tube 21 can advantageously be mounted in the end elements 3 and 4 as described by eliminating a bolt element, wherein the end elements 3 and 4 are supported mutually by means of the permeate tube 21.

A further advantage of the filter device described is in the deflecting disk 9, said disk reliably preventing overloading of the membranes 33 in segments by high fluid flows.

### REFERENCE LIST

1 Membrane insert
2 Housing tube
3 First end element
4 Second end element
5 Inlet tube
6 Outlet tube
7 Connector
8 Flange
9 Deflecting disk
10 Nut
11 Sealing ring
12 Sealing ring
13 Sealing ring
14 Sealing ring
15 Threaded pin
16 Retaining ring
17 Nut
18 Washer
19 Screw
20 Retaining ring
21 Permeate tube
22 Intermediate element
23 Intermediate element
24 Opening
25 Opening
26 Recess
27 Opening
28 Recess
29 Recess
30 Rib
31 Opening
32 Bar
33 Membranes
34 Opening
35 Opening
36 Hollow space
37 Sealing ring
38 Flange segment
D1 Diameter
D2 Diameter

1. A filter device for filtering a fluid, comprising:
a housing having an inlet for the fluid, a permeate outlet for a permeate separated from the fluid, and a retentate outlet for a retentate separated from the fluid;
a membrane insert having a plurality of membranes for filtering the fluid;
wherein the housing comprises a cylindrical housing tube having a first end element at a first tube end and a second tube element at a second tube end, wherein the membrane insert is disposed between the first end element and the second end element, and
wherein the filter device comprises no bolt element connecting the first and second end elements to each other for preloading the first end element and the second end element in the direction of the membrane insert.

2. The filter device according to claim 1,
wherein the filter device comprises no bolt element extending through the membrane insert and the first and/or second end element.

3. The filter device according to claim 1,
wherein the membrane insert comprises a permeate tube connected to the membranes for receiving and discharging the permeate,
wherein the permeate tube extends centrally through the membrane insert and the housing tube,
particularly wherein the permeate tube is free of a bolt element connecting the first and second end elements to each other along a tube axis.

4. The filter device according to claim 3,
wherein a first tube end of the permeate tube contacts the first end element,
and/or wherein a second tube end of the permeate tube contacts the second end element.

5. The filter device according to claim 4,
wherein the first tube end of the permeate tube engages in segments in a central recess of the first end element, said recess limiting the movement of the permeate tube in the direction toward the first end element,
particularly wherein the first tube end of the permeate tube comprises a sealing element.

6. The filter device according to claim 4,
wherein the second tube end of the permeate tube engages in segments in a central opening of the second end element, particularly wherein the second tube end of the permeate tube comprises a sealing element.

7. The filter device according to claim 6,
wherein the opening comprises an internal thread into which a connector is threaded, said connector limiting a movement of the permeate tube in the direction toward the second end element,
particularly wherein the connector comprises a sealing element.

8. The filter device according to claim 1,
wherein the permeate outlet is disposed centrally on the second end element.

9. The filter device according to claim 1,
wherein the inlet is disposed off-center on the first end element (3) and the retentate outlet is disposed off-center on the second end element,
or wherein the inlet is disposed off-center on the second end element and the retentate outlet is disposed off-center on the first end element.

10. The filter device according to claim 1,
wherein the first end element and/or the second end element are each secured by means of one retaining ring against falling out of the housing tube, and
wherein the retaining ring detachably engages in a wall on an inner side of the housing tube.

11. The filter device according to claim 1,
wherein the filter device comprises a preload element having at least one threaded hole, wherein the threaded hole is implemented on the preload element for receiving a screw for preloading the first and/or second end element in the direction of the membrane insert.

12. The filter device according to claim 11,
wherein the preload element is annular in shape and comprises a plurality of threaded holes disposed distributed on the preload element for receiving one screw each for preloading the associated end element in the direction of the membrane insert.

13. The filter device according to claim 1,
wherein at least one deflecting device is disposed between the membrane insert and the inlet and/or the retentate outlet and is implemented for deflecting a fluid flow when the filter device is used as intended.

14. The filter device according to claim 13,
wherein the deflecting device is implemented as a disk element preferably attached to the first or second end element.

15. The filter device according to claim 1,
wherein the membrane insert comprises one mesh-like intermediate element for enclosing the membranes at each of the sides of the membrane insert facing toward the first and second end element.

16. The filter device according to claim 1,
wherein at least part of the membranes engage in segments in the permeate tube and are wound about a permeate tube of the membrane insert.

17. The filter device according to claim 1,
wherein the housing tube is made of a plastic.

18. A filter device for filtering a fluid, comprising:
a housing having an inlet for the fluid, a permeate outlet for a permeate separated from the fluid, and a retentate outlet for a retentate separated from the fluid;
a membrane insert having a plurality of membranes for filtering the fluid;
wherein a deflecting device is disposed between the membrane insert and the inlet and/or the retentate outlet and is implemented for deflecting a fluid flow when the filter device is used as intended.

19. The filter device according to claim 18,
wherein the deflecting device is implemented as a disk element.

20. A filter device for filtering a fluid, comprising:
a housing having an inlet for the fluid, a permeate outlet for a permeate separated from the fluid, and a retentate outlet for a retentate separated from the fluid, wherein the housing comprises a cylindrical housing tube;
a membrane insert having a plurality of membranes for filtering the fluid, wherein the membrane insert comprises a permeate tube connected to the membranes for receiving and discharging the permeate, wherein the permeate tube extends centrally through the membrane insert and the housing tube, and
wherein the permeate tube is clear along the tube axis thereof.
